(19) United States
(12) Patent Application Publication
(10) Pub. No.: US 2007/0100752 A1
(43) Pub. Date: May 3, 2007

(54) SYSTEMS AND METHODS FOR SECURE FINANCIAL TRANSACTION AUTHORIZATION

(76) Inventors: Resh Wallaja, Palo Alto, CA (US); William Revard, Palo Alto, CA (US)

Correspondence Address: RAJEEV MADNAWAT;TM PATENT GROUP, P.O. BOX 360011, MILPITAS, CA, 95036, US

(21) Appl. No.: 11/538,792

(22) Filed: Oct. 4, 2006

Related U.S. Application Data
(60) Provisional application No. 60/724,049, filed on Oct. 6, 2005.

(51) Int. Cl. G06Q 40/00

(52) U.S. Cl. 705/44

(57) ABSTRACT

A system, process and methods for providing secure point of sale and financial transaction authorization, secure party-to-party financial transaction authorization and secure internet transaction authorization using a multi-layer security mechanism aimed at thwarting fraud. A procedure of involving computer system to be utilized with a mobile network to create a secure self-provisioned registration process that will enable creating a secure profile of users that can be subsequently used for logging into a network for transactions in a uncompromised manner.

### CROSS-REFERENCE TO RELATED APPLICATION

This application claims the priority benefit of U.S. Provisional Application No. 60/724049, filed on Oct. 6, 2005, which is incorporated herein by reference.

### BACKGROUND OF INVENTION

1. Field of the Invention

This invention relates to the business practice and processes related to secure point of sale transaction authorization, secure party-to-party financial transaction authorization and secure internet financial transactions.

2. Background and Description of the Related Art

For as long as people have conducted commerce, some number of individuals has engaged in some form of financial fraud, thus taking advantage of the existing financial systems. Financial fraud in this context includes currency counterfeit, credentials counterfeit, authorization fraud and identity theft.

While the methods of authentication and authorization have undergone various forms of progress over the centuries, the current popular practices are easily defeated. Currency counterfeit and credit card fraud cost the domestic financial industries billions of dollars a year and stifle credit availability in developing economies.

The credit card industry initially relied on a credential based system to provide authentication; that is, each account had an associated account number, expiration date, and account name. With that information, and that information alone, a transaction could be initiated. Fraud can easily arise from such a system because the full set of account credentials are always presented for every purchase. The more popular such a system becomes, the more available these full credential sets become and the more opportunity there is for fraud. The credit industry has kept up a vigorous battle against perpetrators; however, enforcement relied on aspects of civil and law enforcement infrastructure that are weak or absent outside of first world economies. Additionally, with the introduction of Internet-based commerce, enforcement is difficult to scale in proportion to the amount of fraud possible on line; there simply are not enough human agents to keep up with the scale of the problem.

Additional strategies have been employed such as imprinting an image of the cardholder on the physical credit card. This has limited utility since it requires a physical examination of the credit card by a store employee who might not be paying attention at the time of purchase; furthermore, this strategy has no value for on line purchases.

### BRIEF DESCRIPTION OF THE DRAWINGS

A better understanding of the present invention can be obtained from the following detailed description in conjunction with the following drawings, in which:

FIG. 1 illustrates current practice of conducting an in-person point of sale financial transaction using a credit or debit card.

FIG. 2 illustrates the concept of multi-layer security in a secure financial transaction.

FIGS. 3, 4, 5, and 6 illustrates a description of how a secure transaction can be carried out using the multi-layer security. FIGS. 3, 4, 5, and 6 represents a continuous flow diagram which has been broken up in four pieces for the purpose of ease of display.

The figures are provided in order to provide a thorough understanding of the present invention. The figures should not be construed as limiting the breath of the invention in any manner.

### DETAILED DESCRIPTION

Current System Of Authorization

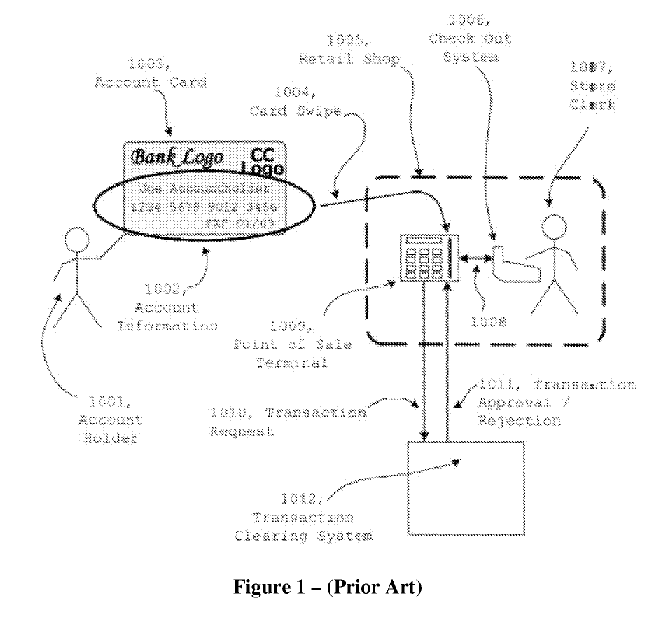

FIG. 1 illustrates a conventional retail transaction using a credit card or debit card. An account holder 1001, being physically present in the retail shop 1005, initiates a transaction presenting their account card 1003. A check out system 1006 may be employed to determine the total amount of the pending transaction, communicating the amount to the point of sales terminal 1009 via some communications means 1008. The point of sale terminal 1009 is used to read the account information 1002, typically via a card swipe 1004, from the account card 1003 and to conduct a secure transaction request 1010 with the transaction clearing system 1012. The account information 1002, a static set of data such as account number, expiration date, etc. is used as the only credential necessary to conduct the transaction. The store clerk 1007 may be called upon to verify a signature or photo, but relying on human diligence as a link in the authentication process has historically proven very weak for a number of reasons that are difficult or impossible to rectify. Before a transaction can complete, the transaction clearing system sends a transaction approval (or rejection) 1011 to the point of sale terminal 1009, notifying the store clerk 1007 to accept the payment (or reject it).

A number of variations are possible from this transaction authorization model; for example, a purchase transaction may be conducted through an internet web site. An internet purchase closely resembles the retail purchase outlined above in that the user account information, a static credential, is the only information unique to the account holder required to initiate a transaction.

Fraud may easily arise in this model because the store clerk has limited means or motivation to accurately validate that the account card actually belongs to the account holder. Furthermore, the actual account holder may engage in fraud by attempting to repudiate a purchase they actually did make.

The underlying property of existing consumer and small company credit and debit instruments is that they all rely on a system of easily obtained static credentials; your credit card number, your name, the account's expiration date, suffix digits printed only on the back of the card, etc. This static credential property is also the fundamental security flaw in the system; authentication is weak and transaction authorization is therefore equally weak. The static credential means a transaction may be conducted at any time, and without the conscious involvement of the account holder. Furthermore, a perpetrator may obtain access to a huge number of accounts or deploy an automated means to conduct the transactions at arm's length or even offshore, making a successfully forensic investigation nearly impossible.

While numerous security means have been proposed, most of these proposed systems involve additional point of sale devices (limiting deployment rate and international acceptance) or methods viewed as intrusive to the user. To become a mainstream method of transaction authorization, the solution needs to be easy, convenient, non-intrusive, and it must not burden the consumer with additional devices. Finally, the solution must solve the very real technical security issues needed to substantially limit the possibility of fraud.

Multi-Layer Secure Transaction System

A procedure of involving computer system to be utilized with a mobile network to create a secure self-provisioned registration process that will enable creating a secure profile of users that can be subsequently used for logging into a network for transactions in a uncompromised manner. The computer system is to have computing power and capacity to handle six to seven thousand concurrent connections per second. A high-availability environment with automatic failover and failback methods.

A programming language such as C++, Java (or similar industry standard programming languages) is to be used to program the computing system to generate various codes such as SCK, UPK, and TAK (described later in this document). The computer system will be coupled to each other using internet or a private network. A standard security protocol (such as VPN etc.) may be employed to secure the network.

The computers will also be programmed to exchange data among themselves as well as communicating with third party service provider computing systems such as bank's computers, merchant's computers.

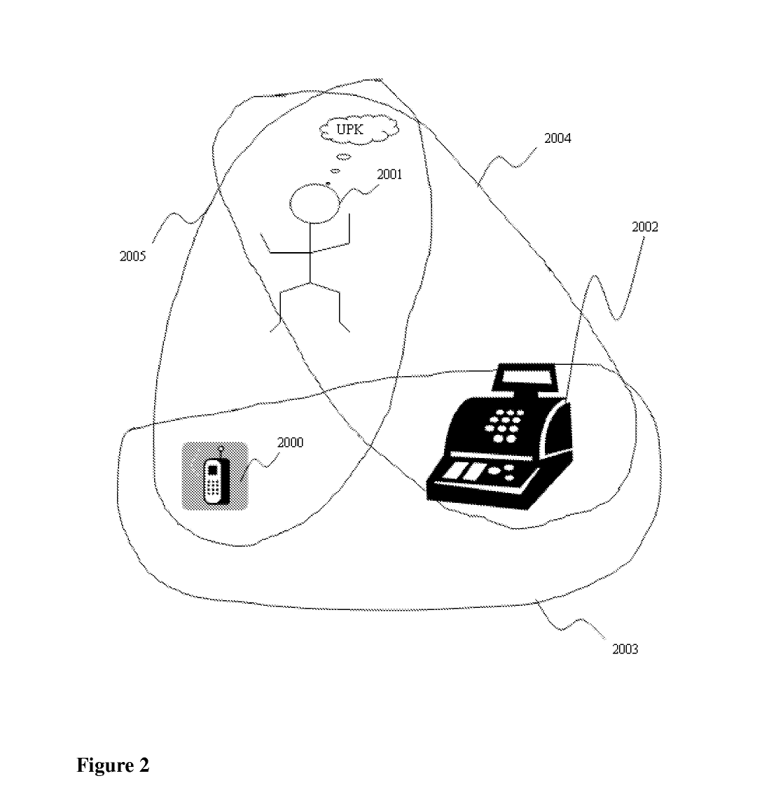

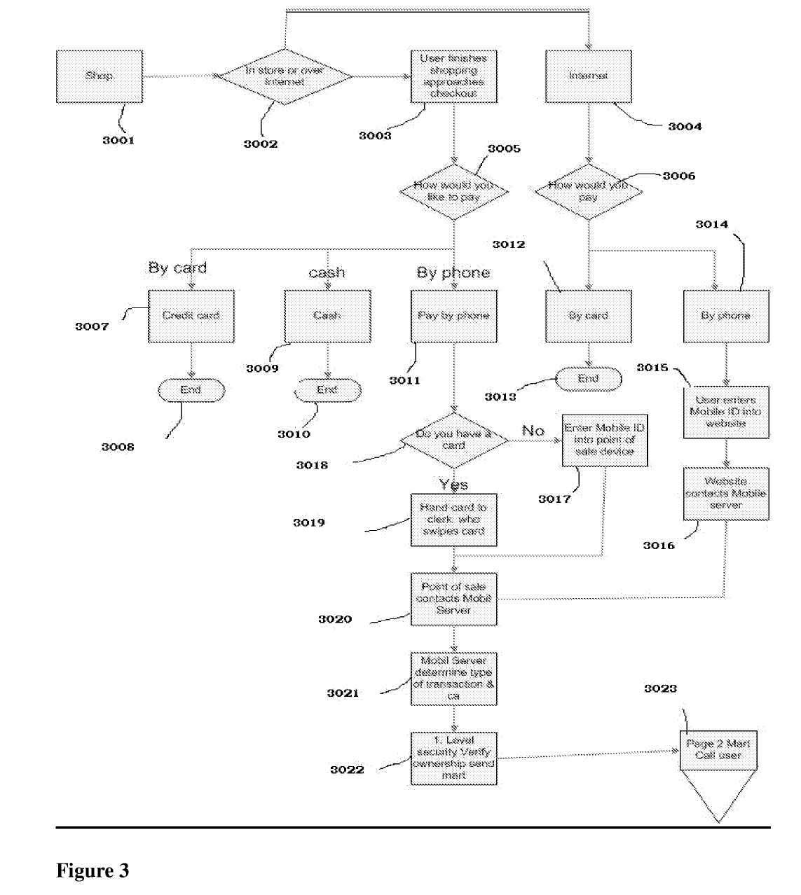

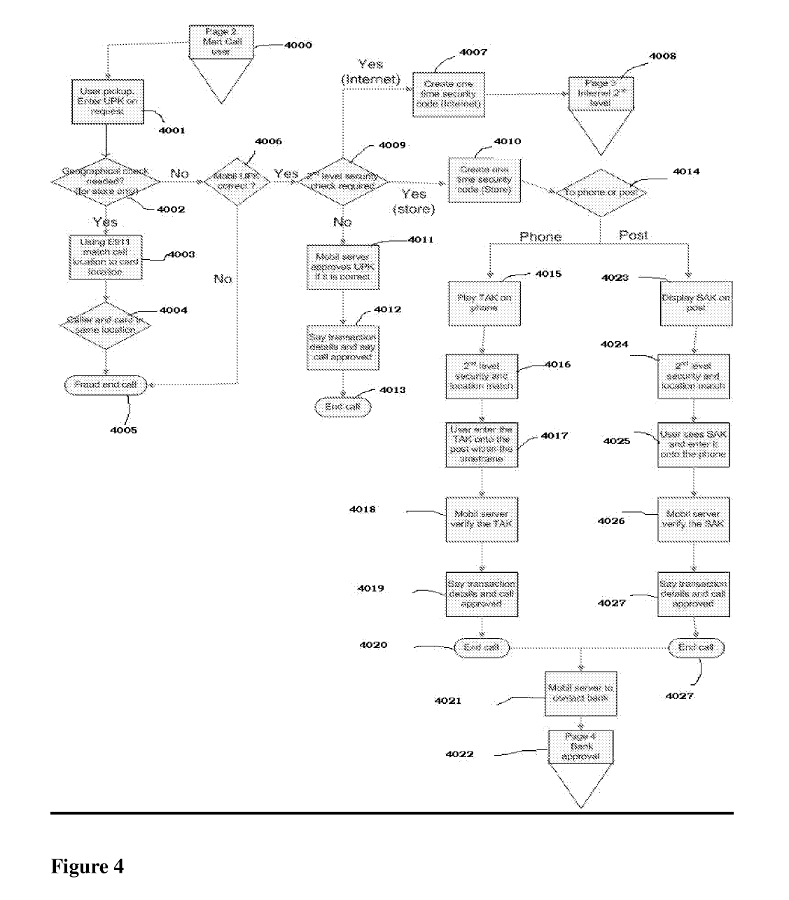

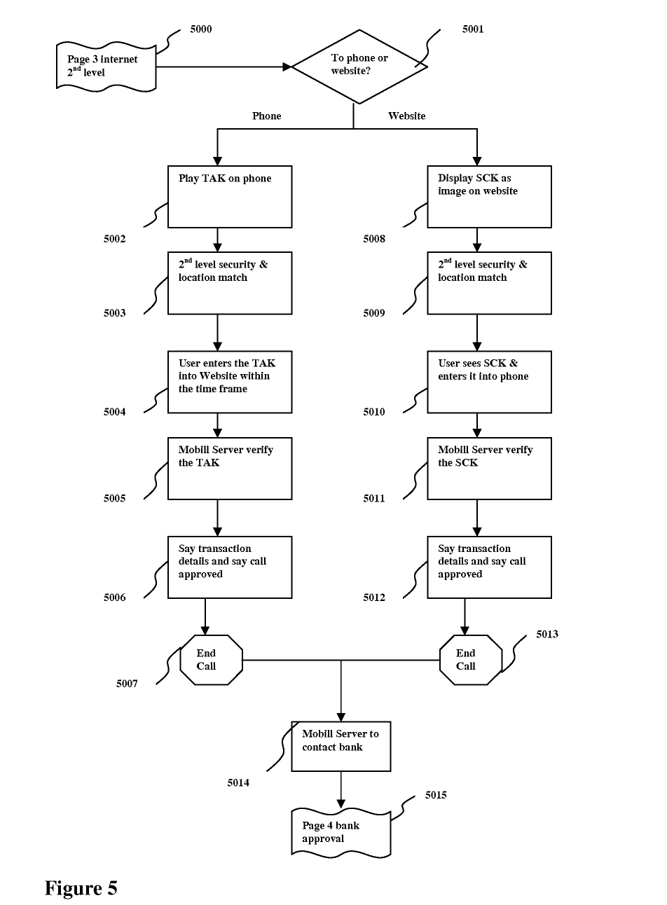

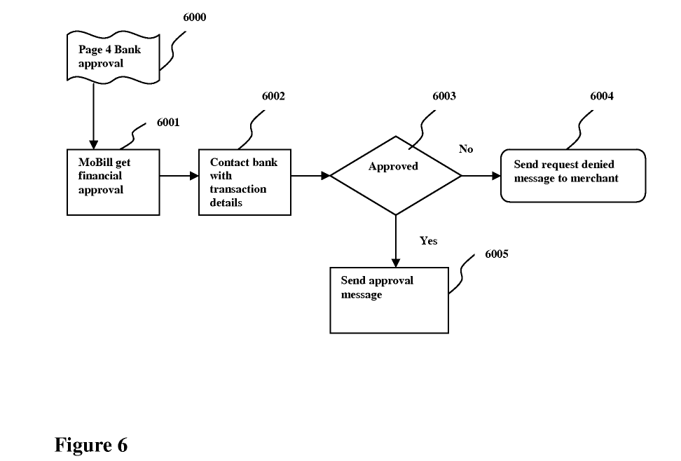

FIG. 2 (continued in FIGS. 3, 4, and 5) illustrates a multi-layer secure financial transition system. Under the system, level I security is provided by providing the user 2001, a user PIN key (UPK) or a password. The user of the financial transaction keeps this key in her/his memory or keeps it at a secure place.

Level II security 2005 comprises confirming that the user 2001 has a cell phone 2000 with him/her during the check out time at the register 2002, or during check out after internet purchase. The cell phone 2000 is registered with the transaction processing entity and calls to complete the transaction are accepted only from this registered number. This security level may not be necessary for internet transactions.

Level III security 2003 comprises confirming transaction location by checking if the registered phone 2000 is in the store at the time of the checkout process. The geographical location may be calculated using the geographical id/co-ordinates provided by the cell phone service provider. This security level may not be necessary for internet transactions.

Level IV security 2004 comprises ensuring the user is at the checkout register 2002. A security code is generated or displayed by the checkout register 2002; this number is then entered into the phone. Alternatively, a code may be displayed by the phone and is then entered into the point of sale checkout register 2002.

As illustrated in FIG. 3, a point of sale financial transaction starts when a buyer finishes shopping 3001 either in store or over internet 3002. In store, the buyer approaches the checkout register 3003; where the buyer is asked 3005 for the method of payment. The buyer decides to conduct the transaction though credit card 3007 or by cash 3009. In either of those two selected methods the transaction ends with 3008 for credit card payment or 3010 for cash transaction.

If he/she chooses to pay by phone 3011 securely, he/she is asked 3018 if he/she has a card containing their mobile id. If a mobile id card is present 3019 then the customer is asked to provide the card to the cashier for swiping else the customer can enter the mobile id number 3017 directly onto the point of sale terminal. In either case the mobile server is contacted by the point of sale device 3020.

The mobile server determines the transaction type 3021. First level of security is performed and verification is send to the MART (Mobill Authorization Transaction Request) 3022. Mart calls the user 3023/4000. User picks up the mobile phone and enters the User Pin Key (UPK) 4001. If a geographical check only is required 4002 then a E911 match 4003 is performed to locate call location to card location. If callee and the card in the same location 4004, then the fraud call ends 4005.

If no geographical check is required 4006, then check for validity of the UPK. If UPK is incorrect then fraud call ends with a failure 4005. If the UPK is correct then a test for a second level of security check requirement is done 4009. If the check is not required then mobile server approves UPK if correct 4011. The transaction detail is approved 4012 and the call ends 4013.

If second level check for Internet is required then create a one time code 4007, which can be passed over the phone or via the Internet 5001. If over the phone then play the Transaction Authorization Key (TAK) on the phone 5002, a second level location and security match is done 5003. User enters the TAK onto the website within the provided timeframe 5004 and the mobile server verifies the TAK 5005, say the transaction details 5006 and end the call 5007. If the code is passed over the Internet 5001, then display Secure Cash Key (SCK) as image on website 5008. Secure Cash Key (SCK) is a authorization key with a limited expiration duration to complete a transaction. If the transaction is not completed within the expiration duration of the SCK, SCK automatically become invalid. A second level security and location match is performed 5009. User sees SCK and enters it on phone 5010. Mobile server verifies SCK 5011, says the transaction details and says call approved 5012. Call ends 5007/5013. Mobile server contacts bank 5014. Mobile server gets financial approval 6001 and contacts bank server with transaction details 6002. If approved by bank server 6003 then send approval message 6005 or send denial 6004.

If second level check for store 4009 then create a one time code for store 4010, which can be passed over the phone or via the Internet 4014. If over the phone then play the Transaction Authorization Key (TAK) on the phone 4015, a second level location and security match is done 4016. Similar to SCK, TAK is also has short life span. If the transaction is not completed within this life span, TAK expires. User enters the TAK onto the website within the provided timeframe 4017 and the mobile server verifies the TAK 4018, say the transaction details 4019 and end the call 4020. If the code is passed over the Internet 4023. A second level security and location match is performed 4024. User sees SCK and enters it on phone 4025. Mobile server verifies SCK 4026, says the transaction details and says call approved 4027. Call ends 4020/4027.

Mobile server contacts bank 4021. Mobile server gets financial approval 6001 and contacts bank server with transaction details 6002. If approved by bank server 6003 then send approval message 6005 or send denial 6004.

A computing system is programmed to generate a unique PUK, SAK and TAK on demand based on the identity profile of a user. This system is also programmed to match the various numbers entered by the users and Point of Sale operators with the system generated numbers for identity and authorization checking purpose. Furthermore, the computing system is programmed to send and receive various messages from/to users, Point of Sale operators, and other computers participating in the authorization of the transaction and processing of the payment, including but not limited to, crediting merchants' account and debiting users' account when the transaction is successful.

A procedure of involving computer system to be utilized with a mobile network to create a secure self-provisioned registration process that will enable creating a secure profile of users that can be subsequently used for logging into a network for transactions in a uncompromised manner. The computer system will be an x86 architecture based PC with computing power and capacity to handle six to seven thousand concurrent connections per second. A high-availability environment with automatic failover and failback methods would be devised into the system.

What is claimed is:

1. A method for conducting a financial transaction authorization comprising:
assigning a user a password;
requiring the user to enter the password;
verifying the password;
contacting a transaction processing server;
determining type of the financial transaction;
verifying geographical location of the user;
generating a TAK code;
playing the TAK code on the user's phone;
requiring user to enter the TAK code within one minute or less;
verifying the TAK code; and
contacting bank to credit merchant's and user's accounts.

2. The method as in claim 1 further comprising:
rejecting the financial transaction if said verifying the password fails.

3. The method as in claim 1 further comprising:
rejecting the financial transaction if said verifying geographical location fails.

4. The method as in claim 1 further comprising:
Rejecting the financial transaction if the user fails to enter TAK code within one minute of said generating of the TAK code.

5. A method for conducting a financial transaction authorization comprising:
assigning a user a password;
requiring the user to enter the password;
verifying the password;
contacting a transaction processing server;
determining type of the financial transaction;
generating a SCK code;
displaying the SCK code on the user's webpage;
requiring user to enter the SCK code within two minute or less;
verifying the SCK code; and
contacting bank to credit merchant's and user's accounts.

6. The method as in claim 1 further comprising:
rejecting the financial transaction if said verifying the password fails.

7. The method as in claim 1 further comprising:
Rejecting the financial transaction if the user fails to enter SCK code within two minute of said generating of the SCK code.

8. A system comprising a group of computers programmed to:
assigning a user a password;
requiring the user to enter the password;
verifying the password;
contacting a transaction processing server;
determining type of the financial transaction;
generating a SCK code;
displaying the SCK code on the user's webpage;
requiring user to enter the SCK code within two minute or less;
verifying the SCK code; and
contacting bank to credit merchant's and user's accounts.
